(19) United States
(12) Patent Application Publication
(10) Pub. No.: US 2005/0017017 A1
(43) Pub. Date: Jan. 27, 2005

(54) Medicament dispenser

(76) Inventors: Gary Thomas Crosby, Ware (GB); Mark Gregory Palmer, Ware (GB)

Correspondence Address: DAVID J LEVY, CORPORATE INTELLECTUAL PROPERTY;GLAXOSMITHKLINE, FIVE MOORE DR., PO BOX 13398, RESEARCH TRIANGLE PARK, NC, 27709-3398, US

(21) Appl. No.: 10/492,458

(22) PCT Filed: Oct. 9, 2002
(86) PCT No.: PCT/EP02/11315

(30) Foreign Application Priority Data
Oct. 19, 2001 (GB) 0125132.1

(51) Int. Cl. G07F 11/66

(52) U.S. Cl. 221/25

(57) ABSTRACT

There is provided a medicament dispenser for use with a medicament carrier (101) having a plurality of pockets for containing medicament wherein said pockets are spaced along the length of and defined between lid (113) and base sheets (111) peelably secured to each other, said dispenser having an internal mechanism for accessing said medicament contained within said medicament carrier. Peeling apart of the two sheets is achieved by drivable motion of a lid sheet drive wheel (218). There is also provided compensation means (222, 322, 522) to compensate for an increase in the diameter of the effective winding surface of the drive wheel (218) during use of the dispenser and thereby to ensure that said medicament carrier is uniformly indexed upon each actuation thereof.

### TECHNICAL FIELD

The present invention relates to a medicament dispenser for dispensing medicament. The invention particularly relates to a device for use in dispensing medicament in powder or tablet form.

### BACKGROUND TO THE INVENTION

The use of inhalation devices in the administration of medicaments, for example in bronchodilation therapy is well known. Such devices generally comprise a body or housing within which a medicament carrier is located. Known inhalation devices include those in which the medicament carrier is a blister strip containing a number of discrete doses of powdered medicament. Such devices usually contain a mechanism of accessing these doses, usually comprising either piercing means or means to peel a lid sheet away from a base sheet. The powdered medicament can then be accessed and inhaled. Such a mechanism may also be used for dispensing medicament in tablet form wherein peeling away the lid sheet from the base sheet reveals a tablet for removal and subsequent consumption.

It is an object of the present invention to simplify the internal mechanism of a medicament dispenser for dispensing medicament in powder or solid form from a medicament carrier as described supra.

Yet another object of the present invention is to provide a device which is refillable by insertion of a replacement cassette containing a medicament carrier. The cassette may be replaced when the medicament carrier is empty. The device is therefore more environmentally friendly as the majority of the device may be retained and is not disposable. It also allows the device to be fitted with additional features such as electronics which may not be cost effective on a completely disposable device.

It is a further object of the present invention that the cassette may be easily removed and that a new replacement cassette can be easily inserted. It is also desirable that the operation of the medicament dispenser be straightforward and non-complex and in particular that the number of separate steps involved in preparing the device for use be minimised. This is especially relevant where the device is designed for use in the delivery of medicament in emergency or rescue situations (e.g. asthma attacks) where simplicity and ease of use is paramount.

When not in use it is desirable from a hygiene standpoint that a mouthpiece, or other medicament exit channel, is provided with some kind of protective cover. The cover desirably acts both to prevent build-up of dirt and to prevent ingress of dirt into the body of the device through the mouthpiece or channel, which might then be subject to inhalation or consumption by a patient. It is also desirable that the cover is in some way attached or mounted to the device to minimise the risk that the cover is misplaced or lost. It is therefore a further object of the present invention for the body of the device to act as a mouthpiece or exit channel cover when the device is in storage and that the cassette is movable relative to the body to enable the mouthpiece or channel to be uncovered for use by the patient.

It is a further object of the invention to provide a medicament dispenser device suitable for use with a large number of discrete doses but which is of an acceptable size for use by patients.

### SUMMARY OF THE INVENTION

Accordingly, in one aspect the invention provides medicament dispenser for use with a medicament carrier having a plurality of pockets for containing medicament wherein said pockets are spaced along the length of and defined between two peelable sheets secured to each other, said dispenser having an internal dispensing mechanism for accessing said medicament contained within said medicament carrier, said mechanism comprising,
a) an opening station for receiving a pocket of said medicament carrier;
b) peeling means positioned to engage a base sheet and a lid sheet of a pocket which has been received in said opening station for peeling apart such a base sheet and lid sheet, to open such a pocket, said peeling means including lid driving means for pulling apart a lid sheet and a base sheet of a pocket that has been received at said opening station, said lid driving means comprising a fixed-diameter wheel on which said lid sheet is wound, said wheel having an effective winding surface, the diameter of which increases as more lid sheet is wound about said wheel,
c) an outlet, positioned to be in communication with an opened pocket through which a user can remove medicament from such an opened pocket; and
d) indexing means for indexing in communication with said outlet, pockets of a medicament carrier in use with said medicament dispenser, said indexing means being interconnected with said lid driving means such that movement of one correlates with the movement of the other,
   additionally comprising compensating means to compensate for any increase in the diameter of said effective winding surface during use of the dispenser and to thereby ensure that said medicament carrier is uniformly indexed upon each actuation of said dispensing mechanism.

The medicament dispenser herein is suitable for use with a medicament carrier having a plurality of pockets for containing medicament wherein said pockets are essentially uniformly spaced along the length of and defined between two peelably separable sheets secured to each other. The medicament carrier is generally in the form of an elongate, peelable blister strip.

As used herein, the term wheel encompasses, for example, a wheel, spindle or spool. The wheel itself has a fixed diameter, although its effective winding diameter (i.e. wheel plus thickness of lid sheet wound therearound) will vary in use as lid sheet is accommodated thereby. The wheel is typically of solid construction and essentially incompressible in nature, at least about its diameter.

A problem encountered with the use of such a wheel as the lid-driving means for driving a lid sheet of a medicament carrier is that as the lid sheet winds up around the wheel the effective winding diameter of the wheel increases, and therefore its effective lateral pulling action (i.e. length of pull) also increases. This is problematic because it is desirable that on actuation, a definable pull action is experienced by the medicament carrier pocket at the opening station to ensure that a generally uniform indexing/opening effect is experienced by each pocket of the medicament carrier. In general terms, insufficient pull action will result in failure to open up the pocket whilst excess pull will stress mechanical components and increase the force required to actuate the dispenser.

One solution to the above problem could involve the use of a wheel of variable actual diameter, for example a wheel of a collapsible nature whose actual diameter reduces as lid sheet is wound therearound. Such wheel forms can however, be more difficult to design/manufacture than a wheel of fixed diameter whose form is non-collapsible.

In accord with the present invention, compensating means are provided to compensate for any increase in the diameter of the effective winding surface of the wheel during use of the dispenser and thereby to ensure that said medicament carrier is uniformly indexed upon each actuation of said dispensing mechanism.

Suitably, the compensating means (e.g. spring or flexible member) is resilient so that on removal of tension from the lid sheet, the compensating means will return to its rest position. Thus, the internal mechanism can be reloaded with a new medicament carrier after the used carrier is removed.

The compensating means may have any suitable form as may be required to achieve its compensating function herein. In aspects, the compensating means is sprung or otherwise tensioned. Tension may be lateral or torsional in nature.

In one aspect, the compensating means are positioned between the opening station and the wheel. The compensating means act such as to reduce the length of lid sheet therebetween to compensate for any increase in the diameter of the effective winding surface of the wheel during use of the dispenser. Thereby, the medicament carrier is uniformly indexed (i.e. typically indexed by the same length of strip) as a result of each actuation of the dispensing mechanism, and that the pocket opening action is uniformly experienced also.

Suitably, the compensating means takes the form of a flexible member positioned between the opening station and the wheel. The flexible member may take the form of a flexible elongate arm about which the lid sheet is fed. The arm may flex inwards as tension in the lid sheet increases, and thus shorten the length of lid sheet between the opening station and the lid driving means.

Suitably, the compensating means takes the form of a spring positioned between the opening station and the wheel that reduces in length as tension increase in the lid sheet between the opening station and the lid driving means. In one aspect, a piston head is mounted on one end of the spring about which the lid sheet is fed. The other end of the spring may be fixed. As tension in the lid sheet increases the piston is driven down onto the spring.

Suitably, the compensating means takes the form of a sprung-loaded tensioner positioned between the opening station and the wheel.

In another aspect, the compensating means is positioned at the wheel. In particular, the compensating means act such as to vary (generally, to reduce) the drive function characteristics of the wheel to compensate for any increase in the diameter of the effective winding surface of the wheel during use of the dispenser. Thereby, the medicament carrier is uniformly indexed (i.e. typically indexed by the same length of strip) as a result of each actuation of the dispensing mechanism, and that the pocket opening action is uniformly experienced also.

Suitably, the compensating means comprises a torsion spring positioned at the wheel. Suitably, the wheel takes a hub form and the torsion spring is accommodated such as to provide a torsion hub drive, which may be driven by gears. In one aspect, in use, the torsion spring is initially tense and the tension reduces as the wheel receives lid sheet thereby also reducing its drive action on later-received lid sheet (i.e. that lid sheet towards the non-already received end of the medicament carrier).

Suitably, the compensating means comprises a constant torque device positioned at the wheel. The constant torque device is arranged to slip at a predetermined torque. In aspects, gearing is provided such that the effective winding surface diameter of the wheel is always greater than that required and the constant torque device slips to accommodate this whilst maintaining desired lid sheet tension.

It will have been appreciated that the compensating means functions such as to compensate for an increase in the diameter of the effective winding surface of the wheel during use of the dispenser. It will be appreciated that the initial effective winding surface and associated initial drive ‘speed’ of the wheel is principally a function of the (fixed) initial diameter of the wheel. Variations are envisaged herein where that initial effective winding surface is selected to define particularly selected initial drive characteristics of the wheel.

In one variation sometimes called ‘one way take up’ mode, the initial effective winding surface is selected such as to initially provide ideal (i.e. uniform) indexing of the medicament carrier. As lid sheet winds up around the wheel the effective winding surface increases and the compensating means acts such as to compensate for that increase.

In another variation sometimes called ‘two way take up’ mode, the initial effective winding surface is selected such as to initially provide non-ideal (i.e. non-uniform) indexing of the medicament carrier because the diameter of the wheel is insufficiently great. As lid sheet winds up around the wheel the effective winding surface increases to an ideal diameter and then on further winding up continues to increase to a non-ideal (i.e. too great diameter). In this embodiment it will be appreciated that the degree and nature of compensation provided by the compensating means will vary over the winding up function. The compensating means initially acts such as to compensate for the insufficient wheel diameter. That compensation then decreases to zero at the point where the diameter of the effective winding surface is ideal. The compensation then progressively acts such as to compensate for a too great effective winding surface. This approach has the advantage of overall reducing the (average) compensating action (e.g. tension) experienced by the medicament carrier from a defined zero (i.e. the ideal) and enables the use of less powerful tensioning means (e.g. smaller springs). In a preferred aspect of this variation, the ideal effective winding surface diameter is selected to correspond approximately to the point at which half of the lid sheet is wound up on the wheel, in which case the average (i.e. mean) compensating action experienced is by the carrier over a full usage cycle is close to zero.

Suitably, said indexing means comprises a rotatable index wheel having recesses therein, said index wheel being engageable with a medicament carrier in use with said medicament dispenser such that said recesses each receive a respective pocket of the base sheet of a medicament carrier in use with said medicament dispenser.

Alternatively, said index means may comprise an indexing ratchet which is moveable between a locked position whereby said ratchet engages a pocket on said medicament carrier and prevents further peeling thereof, and a release position allowing free movement of said medicament carrier, and actuation of said medicament dispenser actuates said lid driving means and releases said index ratchet from said medicament carrier to allow peeling thereof.

Suitably, the medicament dispenser further comprises an indexing lever for actuating said dispenser wherein said indexing lever is interconnected with said indexing means and/or said lid driving means.

In one aspect, the lid driving means and/or the indexing means are operated by an electronic drive system. The electronic drive system may also be used in conjunction with a mechanical drive system.

The electronic drive typically comprises a motor, preferably an electrically-powered motor. The motor may provide linear or rotary drive, but in general, rotary motors are most suitable. The motor may for example, comprise a DC electric motor, a piezoelectric (PZ) motor, an ultrasonic motor, a solenoid motor or a linear motor. Preferably, the electronic drive system comprises a DC motor, a PZ motor or an ultrasonic motor.

The use of ultrasonic motors is particularly preferred since they offer advantages over conventional motors in terms of weight, size, noise, cost and torque generated. Ultrasonic motors are well known in the art and are commercially available (e.g. BMSTU Technological Cooperation Centre Ltd, Moscow, Russia; Shinsei Corporation, Tokyo, Japan).

Ultrasonic motors do not use coils or magnets but comprise a piezo-electric ceramic stator which drives a coupled rotor. The stator generates ultrasonic vibrations which in turn causes rotation of the rotor. While regular DC motors are characterised by high speed and low torque, requiring reduction gearing to increase torque, ultrasonic motors attain low speed and high torque, thus eliminating the need for reduction gearing. Furthermore, these motors are lightweight and compact, lacking coils and magnets, and are noiseless as the ultrasonic frequencies used are not audible to the human ear.

Suitably, the dispenser further comprises actuating means for actuating said electronic drive system. Said actuating means may take the form of a switch, push-button, or lever.

In one aspect, the coil comprising the unused medicament strip is surrounded by a constant force spring. Alternatively the coil comprising the unused medicament strip may be surrounded by an elastomeric band or band comprising a contractible material. The constant force spring, elastomeric band or band comprising a contractible material contracts as the coil reduces in size.

Suitably, said peeling means additionally comprise a guide for guiding the lid sheet and base sheet along separate paths at the opening station. The lid sheet is passed around the guide portion onto the lid driving means.

Alternatively, the guide comprises a roller mechanism. The lid sheet is fed over the rollers onto the lid driving means.

Suitably, the internal mechanism additionally comprises a first chamber in which the strip is initially housed and from which it is dispensed and a second chamber to receive the used portion of the base sheet after it has been indexed and separated from the lid sheet.

Suitably, said first chamber and said second chamber are separated by a wall.

Suitably, said wall is movable to adjust the size of said first and second chambers.

Alternatively, said wall is flexibly movable to adjust the size of the first and second chambers.

Alternatively, the second chamber is expandable to create space for the growing coil of the used portion of the base sheet.

Suitably, the internal mechanism further comprises a third chamber to receive the used portion of the lid sheet and a fourth chamber which houses the indexing means. The fourth chamber may communicate via a slit, which in turn extends upwardly within a mouthpiece or exit channel and communicates with air inlets.

Suitably, the internal mechanism additionally comprises a crushing wheel to crush the medicament pockets after the medicament has been removed from them. The crushing wheel therefore reduces the space, which the used portion of the base sheet takes up.

Typically, the internal mechanism for accessing said medicament contained within said medicament carrier is housed within a cassette.

In one aspect, the invention provides a medicament dispenser for dispensing medicament comprising: a body; a holder, shaped to fit within said body and movable relative to said body; and receivable by said holder, said cassette containing said medicament carrier.

Suitably, movement of the holder relative to the body results in movement of the cassette between a first position and a second position such that the cassette is reversibly removable from the holder when the cassette is in the second position.

Suitably, the first position comprises a dispensing position. Preferably the second position comprises a non-dispensing position. The cassette is therefore only removable from the holder when the cassette is in the non-dispensing position.

Suitably, the holder and body include attaching means to attach the holder to the body. Preferably said attaching means comprise a snap fit mechanism.

Suitably, said snap fit mechanism comprises a pin and hole system.

Suitably, the holder is pivotally movable relative to the body.

Alternatively, the holder is rotationally movable relative to the body.

Suitably, the holder additionally comprises a stop to limit movement of the holder relative to the body. The stop abuts against the edge of the body at two points when it is rotated. At these points the holder may be designed to click into place. Therefore when the stop abuts one body edge then it is clicked into the dispensing position and when the stop abuts the other body edge then it is clicked into the non-dispensing position.

Suitably, the holder is slidably movable relative to the body.

Suitably, the holder additionally comprises a catch to retain the cassette. The catch may for example comprise a sprung pin which fits into a hole or an integral catch which deforms when pressed allowing removal of the cassette.

Suitably, the catch is child resistant. Child resistance may be realised by having a system which forces the user to perform two actions at once to remove the cassette. Other features of the catch may include shock or impact resistance, the ability to lock the catch and orientation features to ensure that the cassette can only be inserted one way. The catch should also be easy to manufacture and assemble, be robust, be composed of a minimal number of components and intrude minimally into the space into which the cassette is inserted.

Suitably, the holder includes guide means to guide the cassette into the holder. Preferably said guide means comprise guide rails. Alternatively the guide means comprise grooves, indentations or other shaping or surface details to define a ‘lock and key’ relationship between the holder and the cassette. Colour guides, arrows and any other surface markings may also be employed.

Suitably, the cassette additionally comprises an indexing lever. The indexing lever has a finger tab located outside the body of the cassette. The rest of the indexing lever is located within the cassette. The indexing lever may have teeth at its tail end and/or teeth along its mid portion.

Suitably, the cassette additionally comprises a mouthpiece.

In one aspect, said mouthpiece is extendable. The mouthpiece extends as the cassette and holder are moved from the non-dispensing position to the dispensing position.

Alternatively, the mouthpiece is retractable. The mouthpiece retracts as the cassette and holder are moved from the dispensing position to the non dispensing position.

In one aspect, the mouthpiece is telescopic.

In another aspect, the mouthpiece is fixed.

The medicament dispenser may also be designed for nasal inhalation of a powdered medicament and may therefore incorporate a nosepiece as an alternative to a mouthpiece. If the medicament is in solid form, the dispenser may incorporate an exit channel for tablet release.

Suitably, the body covers the mouthpiece and indexing lever when the cassette is in the non-dispensing position. This avoids the need for a separate cover and protects the mouthpiece from the ingress of dirt and contaminants during storage.

Suitably, the cassette additionally comprises a raised portion to fit against the holder. The raised portion is located at the opposite end of the cassette to the mouthpiece/nosepiece/exit and indexing lever and prevents the incorrect insertion of the cassette into the holder since it is too wide to fit into the holder. The raised portion is shaped such that it fits against a cut away part of the holder. Preferably said raised portion includes a section which is raised to define a grip portion.

Suitably, at least a portion of the holder and body are shaped for ease of grip by the user.

Suitably, operation of the device may be performed with one hand.

Suitably, the body additionally comprises at least one brush or wiper blade located along its top or bottom side which brush against the top and bottom surfaces of the inside of the cassette. The brush or wiper blade acts to close off the chamber for enclosing the medicament carrier from the rest of the body of the cassette and to prevent any loose powder from entering the rest of the cassette. Loose powder may enter the chamber from the used portion of the blister strip if the patient indexes the strip by pressing the lever when they do not intend to take a dose or when they fail to inhale all the powder.

Suitably, the medicament dispenser comprises an actuation or dose counter for counting the number of actuations of the indexing lever or releases of dose from the cassette. The dose counter may count the number of doses left to be taken or the number of doses taken.

Suitably, said dose counter is electronic. Alternatively, said dose counter is mechanical.

Suitably, said dose counter is located within the cassette. Alternatively, the dose counter is external to the cassette.

Alternatively, the blister strip has printed numbers on it corresponding to the doses in the pockets. Preferably said printed numbers are visible through a window in the cassette. The device may be assembled as follows. The holder is snap fitted into the body. The cassette is assembled separately. The body of the cassette is formed, preferably in two sections with any necessary spindles or integral components formed into the base. Individual components such as indexing wheels, lid winding mechanisms, guide portions etc are then assembled into the base. Finally the medicament containing blister strip (or other suitable medicament carrier) may be inserted into the cassette. This may be wound into the device before the lid is attached to the cassette and the cassette sealed. Alternatively, the cassette may be formed completely apart from a hole left in its side for insertion of the blister strip or medicament carrier. The hole may then be sealed to complete the cassette. This second method of inserting the medicament carrier into the device has the advantage that it is much simpler.

Suitably, the medicament dispenser additionally comprises an electronic data management system. The electronic data management system has input/output capability and comprises a memory for storage of data; a microprocessor for performing operations on said data; and a transmitter for transmitting a signal relating to the data or the outcome of an operation on the data.

Suitably, the electronic data management system is arranged to be responsive to or activated by the voice of a user. Thus, for example the system may be switched on or off in response to a voice command.

The electronic data management system may be integral with the body. Alternatively, the electronic data management system forms part of a base unit which is reversibly associable with the body.

Suitably, the medicament dispenser additionally comprises a data input system for user input of data to the electronic data management system. Preferably, the data input system comprises a man machine interface (MMI) preferably selected from a keypad, voice recognition interface, graphical user interface (GUI) or biometrics interface.

Energy may be conserved by a variety of means to enable the device to operate for longer on a given source of energy, such as a battery. Energy conservation or saving methods have additional advantages in terms of reducing the size requirements of the power source (e.g. battery) and thus the weight and portability of the medicament dispenser.

A variety of energy saving methods are available which generally involve reducing power consumption. One such method is to use a clock or timer circuit to switch the power on and off at regular or predetermined intervals. In another method the system can selectively switch on/off specific electronic devices, such as visual display units or sensors, in order to power these devices only when they are required to perform a particular sequence of events. Thus different electronic devices may be switched on and off at varying intervals and for varying periods under control of the system. The power sequencing system may also respond to a sensor, such as a motion or breath sensor, which is activated on use of the device.

Low power or “micropower” components should be used within the electronics where possible and if a high power device is required for a particular function this should be put into a low power standby mode or switched off when not required. Similar considerations apply in the selection of transducers. Operation at low voltage is desirable since power dissipation generally increases with voltage.

For low power digital applications complementary metal oxide semi-conductor (CMOS) devices are generally preferred and these may be specially selected by screening for low quiescent currents. Clock speeds of processors and other logic circuits should be reduced to the minimum required for computational throughput as power consumption increases with frequency. Supply voltages should also be kept at minimal values consistent with reliable operation because power dissipation in charging internal capacitance's during switching is proportional to the square of the voltage. Where possible, supply voltages should be approximately the same throughout the circuit to prevent current flowing through input protection circuits. Logic inputs should not be left floating and circuits should be arranged so that power consumption is minimised in the most usual logic output state. Slow logic transitions are undesirable because they can result in relatively large class-A currents flowing. Resistors may be incorporated in the power supply to individual devices in order to minimise current in the event of failure.

In some control applications, devices that switch between on and off states are preferred to those that allow analog (e.g. linear) control because less power is dissipated in low resistance on states and low current off states. Where linear components are used (e.g. certain types of voltage regulators) then types with low quiescent currents should be selected. In some circuit configurations it is preferable to use appropriate reactive components (i.e. inductors and capacitors) to reduce power dissipation in resistive components.

Suitably, the system additionally comprises a visual display unit for display of data from the electronic data management system to the user. The display may for example, comprise a screen such as an LED or LCD screen. More preferably the visual display unit is associable with the body of the medicament dispenser.

Suitably, the medicament dispenser additionally comprises a datalink for linking to a local data store to enable communication of data between the local data store and the electronic data management system. The datastore may also comprise data management, data analysis and data communication capability.

The datastore may itself form part of a portable device (e.g. a handheld device) or it may be sized and shaped to be accommodated within the patients home. The datastore may also comprise a physical storage area for storage of replacement cassettes. The datastore may further comprise a system for refilling medicament from a reservoir of medicament product stored therewithin. The datastore may further comprise an electrical recharging system for recharging any electrical energy store on the medicament dispenser, particularly a battery recharging system.

The datalink may for example enable lining with a docking station, a personal computer, a network computer system or a set-top box by any suitable method including a hard-wired link, an infra red link or any other suitable wireless communications link.

Suitably, the medicament dispenser additionally comprises an actuation detector for detecting actuation of the dispensing mechanism wherein said actuation detector transmits actuation data to the electronic data management system.

The medicament dispenser may additionally comprise a safety mechanism to prevent unintended multiple actuations of the dispensing mechanism. The patient is thereby protected from inadvertently receiving multiple doses of medicament in a situation where they take a number of short rapid breaths. More preferably, the safety mechanism imposes a time delay between successive actuations of the release means. The time delay is typically of the order of from three to thirty seconds.

Suitably, the medicament dispenser additionally comprises a release detector for detecting release of medicament from the cassette, wherein said release detector transmits release data to the electronic data management system.

Suitably, the medicament dispenser additionally comprises a shake detector for detecting shaking of the medicament container (e.g. prior to actuation of the dispensing mechanism), wherein said shake detector transmits shake data to the electronic data management system.

Suitably, any actuation detector, release detector, or shake detector comprises a sensor for detecting any suitable parameter such as movement. Any suitable sensors are envisaged including the use of optical sensors. The release detector may sense any parameter affected by release of the medicament such as pressure, temperature, sound, moisture, carbon dioxide concentration and oxygen concentration.

Suitably, the medicament dispenser additionally comprises a breath trigger for triggering the dispensing mechanism, said breath trigger being actuable in response to a trigger signal from the electronic data management system. Preferably, the electronic data management system includes a predictive algorithm or look-up table for deriving from the breath data when to transmit the trigger signal. For example, a real-time analysis of the patient breath waveform may be made and the trigger point derived by reference to that analysed waveform.

Suitably, the electronic data management system includes a predictive algorithm or look-up table for calculating the optimum amount of medicament to dispense.

Suitably, the memory on the electronic data management system includes a dose memory for storing dosage data and reference is made to the dose memory in calculating the optimum amount of medicament to dispense.

Suitably, the medicament dispenser additionally comprises a selector for selecting the amount of medicament to dispense from said dispensing mechanism. In one aspect, the selector is manually operable. In another aspect, the selector is operable in response to a signal from the transmitter on the electronic data management system.

Suitably, the medicament dispenser comprises in association with a body or housing thereof, a first transceiver for transmitting and receiving data and in association with the medicament container, a second transceiver for transmitting and receiving data, wherein data is transferable in two-way fashion from the first transceiver to the second transceiver. The data is preferably in digital form and suitable for transfer by electronic or optical means.

One advantage of embodiments of this type is the ability to store many types of information in different parts of the memory structure of the transceivers. The information is furthermore stored in a form which is readily and accurately transferable. The information could for example, include manufacturing and distribution compliance information written to the memory at various points in the manufacturing or distribution process, thereby providing a detailed and readily accessible product history of the dispenser. Such product history information may, for example, be referred to in the event of a product recall. The compliance information could, for example, include date and time stamps. The information could also include a unique serial number stored in encrypted form or in a password protectable part of the memory which uniquely identifies the product and therefore may assist in the detection and prevention of counterfeiting. The information could also include basic product information such as the nature of the medicament and dosing information, customer information such as the name of the intended customer, and distribution information such as the intended product destination.

On loading or reloading the medicament dispenser with a cassette the second transceiver may, for example, read the unique serial number, batch code and expiry date of the medicament and any other information on the second transceiver. In this way the nature and concentration of the medicament, together with the number of doses used or remaining within the cassette, may be determined. This information can be displayed to the patient on a visual display unit. Other information, such as the number of times the medicament dispenser has been reloaded with a cassette, may also be displayed.

Similarly, should the cassette be removed from the holder before the supply of medicament is exhausted, the same data can be read from the second transceiver and the number of doses remaining or used determined. Other information, such as the date and time of administration of the drug, or environmental exposure data such as the minimum/maximum temperatures or levels of humidity the cassette has been exposed to, may also be read and displayed to the user.

In the event that the supply of medicament within the container becomes exhausted, or that the shelf life of the medicament has expired, or that the first transceiver does not recognise the batch code on the second transceiver, activation of the dispenser may be prevented to safeguard the user. Activation may also be prevented if the medicament has been exposed to extreme environmental conditions for periods outwith the manufacturer's guidelines.

Data may be transferred to and from any transceiver during the period of use of the medicament dispenser by the patient. For example, the medicament dispenser may include an electronic data management system having various sensors associated therewith. Any data collected by the sensors or from any data collection system associated with the electronic data management system including a clock or other date/time recorder is transferable.

Data may be transferred each time the patient uses the device. Or alternatively, data may be stored in a database memory of the electronic data management system and periodically downloaded to any transceiver. In either case, a history of the usage of the device may be built up in the memory of a transceiver.

In one embodiment herein, a history of the usage of the medicament dispenser is transferred to the second transceiver. When the blister strip in the cassette is exhausted it is exchanged by the patient for a new refill cassette. At the point of exchange, which will typically occur at the pharmacy, data may be transferred from the exhausted cassette to the refill and vice-versa. Additionally, usage history data may be read from the refill and transferred to a healthcare data management system for example comprising a network computer system under the control of a healthcare data manager.

Methods are envisaged herein whereby the patient is given some sort of reward for returning the refill and making available the data comprised within the second transceiver. Methods are also envisaged herein whereby the healthcare data manager is charged for either receipt of the data from the second transceiver or for its use for commercial purposes. Any rewards or charging may be arranged electronically. The methods may be enabled by distributed or web-based computer network systems in which any collected data is accessible through a hub on the network. The hub may incorporate various security features to ensure patient confidentiality and to allow selective access to information collected dependent upon level of authorisation. The level of user authorisation may be allocated primarily to safeguard patient confidentiality. Beyond this the level of user authorisation may also be allocated on commercial terms with for example broader access to the database being authorised in return for larger commercial payments.

Suitably, the first and second transceiver each comprise an antenna or equivalent for transmitting or receiving data and connecting thereto a memory. The memory will typically comprise an integrated circuit chip. Either transceiver may be configured to have a memory structure which allows for large amounts of information to be stored thereon. The memory structure can be arranged such that parts of the memory are read-only, being programmed during/after manufacture, other parts are read/write and further parts are password protectable. Initial transfer of information (e.g. on manufacture or one dispensing) to or from any transceiver can be arranged to be readily achievable by the use of a reader which is remote from the medicament dispenser, thereby minimising the need for direct product handling. In further aspects, the reader can be arranged to simultaneously read or write to the memory of multiple transceivers on multiple medicament dispensers.

A suitable power source such as a battery, clockwork energy store, solar cell, fuel cell or kinetics-driven cell will be provided as required to any electronic component herein. The power source may be arranged to be rechargeable or reloadable.

Suitably, data is transferable in two-way fashion between the first and second transceiver without the need for direct physical contact therebetween. Preferably, data is transferable wirelessly between the first and second transceiver.

Suitably, the first transceiver is an active transceiver and the second transceiver is a passive transceiver. The term active is used to mean directly-powered and the term passive is used to mean indirectly-powered.

Suitably, the second transceiver comprises a label or tag comprising an antenna for transmitting or receiving energy; and an integrated circuit chip connecting with said antenna, and the first transceiver comprises a reader for said label or tag. In this case the label or tag is a passive transceiver and the reader is an active transceiver.

Preferably, the reader will not need to be in direct contact with the tag or label to enable the tag or label to be read.

The tag may be used in combination and/or integrated with other traditional product labelling methods including visual text, machine-readable text, bar codes and dot codes.

Suitably, the integrated circuit chip has a read only memory area, a write only memory area, a read/write memory area or combinations thereof.

Suitably, the integrated circuit chip has a one-time programmable memory area. More preferably, the one-time programmable memory area contains a unique serial number.

Suitably, the integrated circuit chip has a preset memory area containing a factory preset, non-changeable, unique data item. The preset memory item is most preferably in encrypted form.

Suitably, the integrated circuit chip has plural memory areas thereon. Suitably, any memory area is password protected.

Suitably, any memory area contains data in encrypted form. Electronic methods of checking identity, error detection and data transfer may also be employed.

In one aspect, the integrated circuit has plural memory areas thereon including a read only memory area containing a unique serial number, which may for example be embedded at the time of manufacture; a read/write memory area which can be made read only once information has been written thereto; and a password protected memory area containing data in encrypted form which data may be of anti-counterfeiting utility.

Suitably, the tag is on a carrier and the carrier is mountable on the body or holder of the medicament dispenser or on the cassette.

In one aspect, the carrier is a flexible label. In another aspect, the carrier is a rigid disc. In a further aspect, the carrier is a rectangular block. In a further aspect, the carrier is a collar ring suitable for mounting to the neck of an aerosol container. Other shapes of carrier are also envisaged.

Suitably, the carrier is mouldable or weldable to the cassette or housing. Suitably, the carrier encases the tag. More preferably, the carrier forms a hermetic seal for the tag.

In one aspect, the carrier comprises an insulating material such as a glass material or, a paper material or an organic polymeric material such as polypropylene. Alternatively, the carrier comprises a ferrite material.

The energy may be in any suitable form including ultrasonic, infrared, radiofrequency, magnetic, optical and laser form. Any suitable channels may be used to channel the energy including fibre optic channels.

In one aspect, the second transceiver comprises a radiofrequency identifier comprising an antenna for transmitting or receiving radiofrequency energy; and an integrated circuit chip connecting with said antenna, and the first transceiver comprises a reader for said radiofrequency identifier. In this case the radiofrequency identifier is a passive transceiver and the reader is an active transceiver. An advantage of radiofrequency identifier technology is that the reader need not be in direct contact with the radiofrequency identifier tag or label to be read.

The radiofrequency identifier can be any known radiofrequency identifier. Such identifiers are sometimes known as radiofrequency transponders or radiofrequency identification (RFID) tags or labels. Suitable radiofrequency identifiers include those sold by Phillips Semiconductors of the Netherlands under the trade marks Hitag and Icode, those sold by Amtech Systems Corporation of the United States of America under the trade mark Intellitag, and those sold by Texas Instruments of the United States of America under the trade mark Tagit.

Suitably, the antennae of the RFID tag is capable of transmitting or receiving radiofrequency energy having a frequency of from 100 kHz to 2.5 GHz. Preferred operating frequencies are selected from 125 kHz, 13.56 MHz and 2.4 GHz.

In one aspect, the second transceiver comprises a magnetic label or tag comprising an antenna for transmitting or receiving magnetic field energy; and an integrated circuit chip connecting with said antenna, and the first transceiver comprises a reader for said magnetic label or tag. In this case the magnetic label or tag is a passive transceiver and the reader is an active transceiver.

A suitable magnetic label or tag comprises plural magnetic elements in mutual association whereby the magnetic elements move relative to each other in response to an interrogating magnetic field. A magnetic label or tag of this type is described in U.S. Pat. No. 4,940,966. Another suitable magnetic label or tag comprises a magnetorestrictive element which is readable by application of an interrogating alternating magnetic field in the presence of a magnetic bias field which results in resonance of the magnetorestrictve elements at different predetermined frequencies. A magnetic label of this type is described in PCT Patent Application No. WO92/12402. Another suitable magnetic label or tag comprising plural discrete magnetically active regions in a linear array is described in PCT Patent Application No. WO96/31790. Suitable magnetic labels and tags include those making use of Programmable Magnetic Resonance (PMR) (trade name) technology.

In another aspect, the second transceiver comprises a microelectronic memory chip and the first transceiver comprises a reader for said microelectronic memory chip. The microelectronic memory chip may comprise an Electrically Erasable

Programmable Read Only Memory (EEPROM) chip or a SIM card-type memory chip. In this case the microelectronic memory chip is a passive transceiver and the reader is an active transceiver.

Any transceiver herein, particularly a passive transceiver may be mounted on or encased within any suitable inert carrier. The carrier may comprise a flexible sheet which may in embodiments be capable of receiving printed text thereon.

In one aspect, the first transceiver is integral with the body such that a single unit is comprised. The first transceiver may for example be encased within or moulded to the body.

In another aspect, the first transceiver forms part of a base unit which is reversibly associable with the body. The base unit may for example, form a module receivable by the body such as a snap-in module.

Suitably, the medicament dispenser additionally comprises a communicator for wireless communication with a network computer system to enable transfer of data between the network computer system and the electronic data management system. Dispensers employing such communicators are described in pending PCT Applications No.s PCT/EP00/09291 (PG3786), PCT/EP00/09293 (PG4029) and PCT/EP00/09292 (PG4159). Preferably, the communicator enables two-way transfer of data between the network computer system and the electronic data management system.

Suitably, the data is communicable between the network computer system and the electronic data management system in encrypted form. All suitable methods of encryption or partial encryption are envisaged. Password protection may also be employed. Suitably, the communicator employs radiofrequency or optical signals.

In one aspect, the communicator communicates via a gateway to the network computer system. In another aspect, the communicator includes a network server (e.g. a web server) such that it may directly communicate with the network.

In a further aspect, the communicator communicates with the gateway via a second communications device. Preferably, the second communications device is a telecommunications device, more preferably a cellular phone or pager. Preferably, the communicator communicates with the second communications device using spread spectrum radiofrequency signals. A suitable spread spectrum protocol is the Bluetooth (trade mark) standard which employs rapid (e.g. 1600 times a second) hopping between plural frequencies (e.g. 79 different frequencies). The protocol may further employ multiple sending of data bits (e.g. sending in triplicate) to reduce interference.

In one aspect, the network computer system comprises a public access network computer system. The Internet is one suitable example of a public access network computer system, wherein the point of access thereto can be any suitable entrypoint including an entrypoint managed by an Internet service provider. The public access network computer system may also form part of a telecommunications system, which may itself be either a traditional copper wire system, a cellular system or an optical network.

In another aspect, the network computer system comprises a private access network computer system. The private access network system may for example, comprise an Intranet or Extranet which may for example, be maintained by a health service provider or medicament manufacturer. The network may for example include password protection; a firewall; and suitable encryption means.

Preferably, the communicator enables communication with a user-specific network address in the network computer system.

The user-specific network address may be selected from the group consisting of a web-site address, an e-mail address and a file transfer protocol address. Preferably, the user-specific network address is accessible to a remote information source such that information from said remote information source can be made available thereto.

More preferably, information from the user-specific network address can be made available to the remote information source.

In one aspect, the remote information source is a medicament prescriber, for example a doctors practice. Information transferred from the medicament prescriber may thus, comprise changes to prescription details, automatic prescription updates or training information. Information transferred to the medicament prescriber may comprise compliance information, that is to say information relating to the patent's compliance with a set prescribing programme. Patent performance information relating for example, to patient collected diagnostic data may also be transferred to the medicament prescriber. Where the dispenser is an inhaler for dispensing medicament for the relief of respiratory disorders examples of such diagnostic data would include breath cycle data or peak flow data.

In another aspect, the remote information source is a pharmacy. Information transferred from the pharmacy may thus, comprise information relating to the medicament product Information sent to the pharmacy may thus include prescription requests which have been remotely pre-authorised by the medicament prescriber.

In a further aspect, the remote information source is an emergency assistance provider, for example a hospital accident and emergency service or an emergency helpline or switchboard. The information may thus, comprise a distress or emergency assist signal which requests emergency assistance.

In a further aspect, the remote information source is a manufacturer of medicament or medicament delivery systems. Information transferred to the system may thus, comprise product update information. The system may also be configured to feed information back to the manufacturer relating to system performance.

In a further aspect, the remote information source is a research establishment. In a clinical trial situation, information may thus be transferred relating to the trial protocol and information relating to patient compliance fed back to the research establishment.

In a further aspect, the remote information source is an environmental monitoring station. Information relating to weather, pollen counts and pollution levels may thus be made accessible to the system.

Suitably, the medicament dispenser additionally comprises a geographic positioning system such as a global positioning system or a system which relies on the use of multiple communications signals and a triangulation algorithm.

The medicament may comprise a capsule, pellet or tablet. Alternatively, the medicament may be in powdered form. Preferably, when in powdered form the medicament comprises a drug. Preferably the drug is selected from the group consisting of albuterol, salmeterol, fluticasone propionate and beclomethasone dipropionate and salts or solvates thereof and any combination thereof. Preferably said combination comprises salmeterol xinafoate and fluticasone propionate.

Suitably, the powdered medicament additionally comprises an excipient. Suitably, said excipient is a sugar.

In yet another aspect, the invention provides a kit of parts comprising a cassette as described supra, a holder for a cassette and a body wherein the holder is shaped to fit within said body and may be movable relative to said body.

In a further aspect, the invention provides a body and holder for use in the medicament dispenser described supra.

In still a further aspect, the invention provides a cassette for use in the medicament dispenser described supra.

In yet another aspect, the invention provides the use of a medicament dispenser as described supra.

### BRIEF DESCRIPTION OF THE DRAWINGS

The invention will now be described with reference to the accompanying drawings in which:

FIG. 1 shows a perspective view of a medicament carrier in accordance with the present invention;

FIG. 2 shows a base unit housing an internal mechanism in accordance with one aspect of the invention;

FIG. 3 shows a base unit housing an internal mechanism according to another aspect of the invention;

FIG. 4 shows a perspective view of a medicament dispenser according to the invention with the cassette removed from the holder and the body;

FIG. 5 shows a base unit housing an internal mechanism according to another aspect of the invention; and

FIG. 6 shows a graphic representation of strip lid foil tension versus strip pocket number for ‘one way take up’ and ‘two way take up’ modes herein.

### DETAILED DESCRIPTION OF THE DRAWINGS

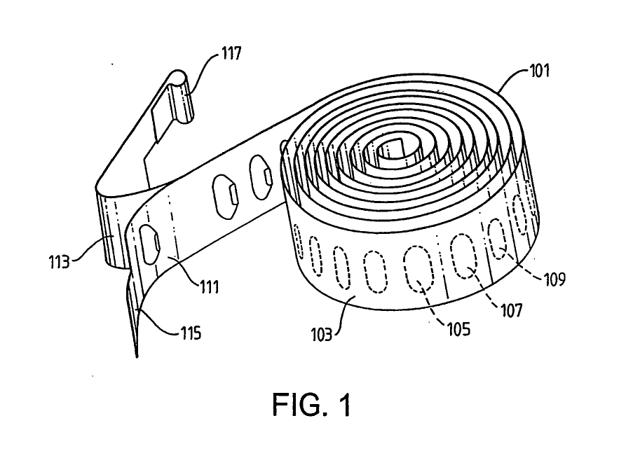

Referring now to the Figures, FIG. 1 shows a medicament carrier 101 in accord with the present invention. The medicament carrier comprises a flexible strip 103 defining a plurality of pockets 105, 107, 109 each of which contains a dose of medicament which can be inhaled, in the form of powder.

The strip comprises a base sheet 111 in which blisters are formed to define the pockets 105, 107, 109 and a lid sheet 113 which is hermetically sealed to the base sheet except in the region of the blisters in such a manner that the lid sheet 113 and the base sheet 111 can be peeled apart. The sheets 111, 113 are sealed to one another over their whole width except for the leading end portions 115, 117 where they are preferably not sealed to one another at all. The lid 113 and base 111 sheets are each preferably formed of a plastics/aluminium laminate and are preferably adhered to one another by heat sealing.

The strip 103 is shown as having uniformly-spaced elongate pockets 105, 107, 109 that run transversely with respect to the length of the strip 103. This is convenient in that it enables a large number of pockets 105, 107, 109 to be provided in a given strip 103 length. The strip 103 may, for example, be provided with sixty or one hundred pockets but it will be understood that the strip 103 may have any suitable number of pockets.

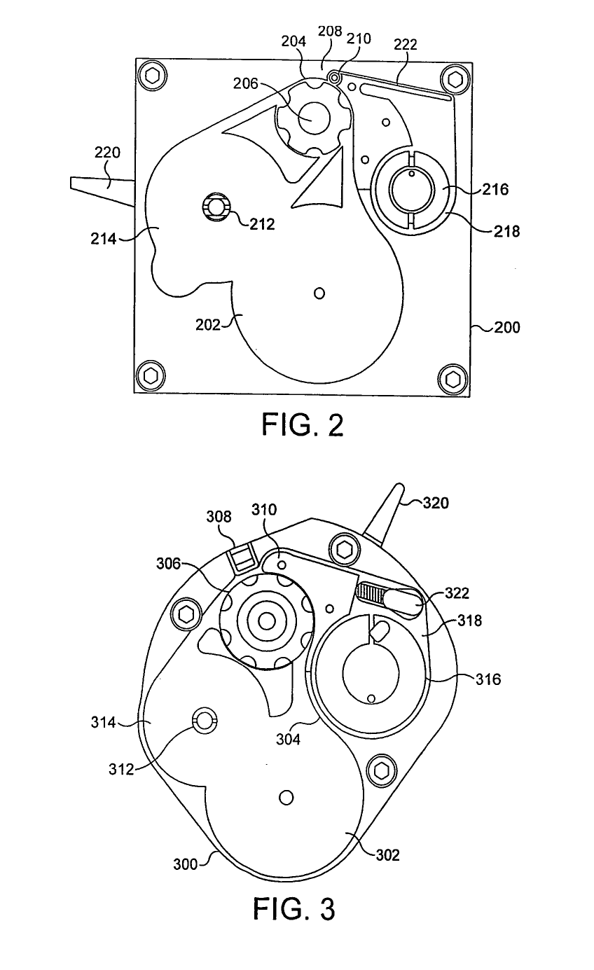

FIG. 2 illustrates a base unit 200 of a medicament dispenser according to the invention. A medicament strip (not shown for clarity) is positioned in chamber 202 of the base unit 200. The strip is pre-fed through a guide member 204 within the manifold component and engaged in a six-pocket index wheel 206. The first pocket of the strip is positioned one pocket away from the opening station 208. The lid foil and base foil are separable about a beak 210. The resulting empty base foil is coiled about a base take-up spindle 212 in the base take-up chamber 214. The used lid foil is fed over the beak 210 and coiled about a lid take-up spindle 216 in the lid take-up chamber 218.

To actuate the dispenser, the index lever 220 is turned until it reaches a stop (not shown). The index lever 220 is interconnected with the index wheel 206, the base take-up spindle 212 and the lid take-up spindle 216, through a simple gear train (not shown). The index lever 220 thus indexes the strip and coils up the waste foils.

Initially, the gearing between the index wheel 206 and the lid take-up foil spindle 216 is one-to-one. However, as the lid take up spindle 216 winds on more foil, its effective winding diameter increases. An increase in diameter would cause the lid take-up spindle 216 to pull more strip than the index lever 220 releases. Thus, compensating means in the form of a flexible member 222, which is positioned in the lid foil path between the index wheel 206 and the lid take-up spindle 216, flexes, such that the flexible member 222 reduces the distance between the index wheel 206 and the lid take-up spindle 216 and thereby compensates for the Incremental change in strip length pulled by the take-up spindle 216.

FIG. 3 illustrates a base unit 300 of a medicament dispenser according to the invention. A medicament strip (not shown for clarity) is positioned in chamber 302 of the base unit 300. The strip is pre-fed through a guide member 304 within the manifold component and engaged in eight-pocket index wheel 306. The first pocket of the strip is positioned one pocket away from the opening station 308. The lid foil and base foil are separable about a beak 310. The resulting empty base foil is coiled about a base take-up spindle 312 in the base take-up chamber 314. The used lid foil is fed over the beak 310 and coiled about a lid take-up spindle 316 in the lid take-up chamber 318.

To actuate the dispenser, the index lever 320 is turned until it reaches a stop (not shown). The index lever 320 is interconnected with the index wheel 306, the base take-up spindle 312 and the lid take-up spindle 316, through a simple gear train (not shown). The index lever 320 thus indexes the strip and coils up the waste foils.

Initially, the gearing between the index wheel 306 and the lid take-up foil spindle 316 is one-to-one. However, as the lid take up spindle 316 winds on more foil, its effective winding diameter increases. An increase in diameter would cause the lid take-up spindle 316 to pull more strip than the index lever 320 releases. Thus, compensating means in the form of a sprung-loaded tensioner 322, which is positioned in the lid foil path between the index wheel 306 and the lid take-up spindle 316, flexes, such that the sprung-loaded tensioner 322 reduces the distance between the index wheel 306 and the lid take-up spindle 316 and thereby compensates for the incremental change in strip length pulled by the take-up spindle 316.

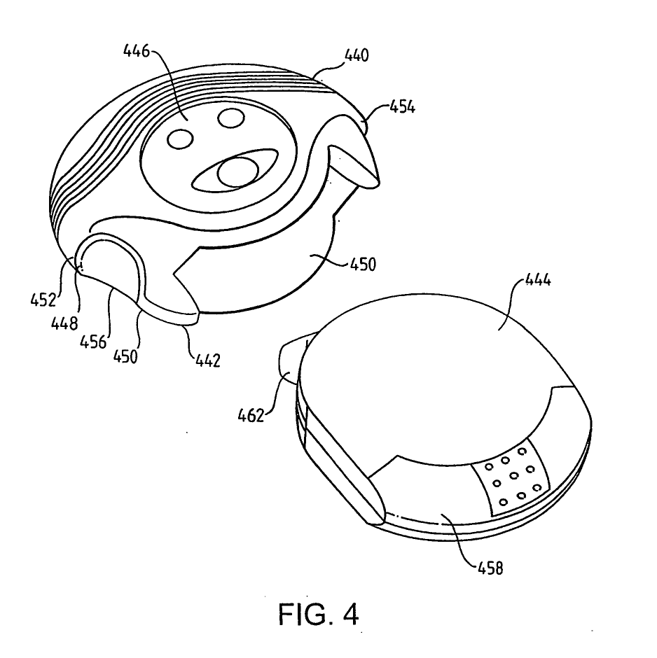

FIG. 4 shows a medicament dispenser in accord with the present invention, comprising a body 440, a holder 442, refill cassette 444 and electronic display 446. The holder 442 is shaped to fit snugly inside body 440 and is fixed to a point on the body (not shown) about which it rotates. Stops 448, 450 protrude from the holder 442 and prevent the holder 442 from rotating more than about 180° relative to the body 440. The stops 448, 450 also provide two defined positions of the holder 442 within the body 440. One position is defined by stop 448 meeting with body edge 452 and the other position defined by stop 450 meeting with body edge 454 when the holder has been rotated relative to the body. The area between stops 448 and 450 is shaped to form a thumb or finger grip 456 for the user of the device. The holder 442 forms a shell into which the refill cassette 444 snugly fits.

The refill cassette 444 comprises a shell containing the medicament carrier (not shown) and a mechanism for opening the carrier (not shown) for the medicament to be accessed. The refill cassette 444 has a raised portion 458 at one end on both sides along its width so that this part of the refill cassette 444 is at least the same depth as the part of the holder 460 which receives the refill cassette 444. This allows the position of the cassette 444 within the holder 442 to be fixed such that the ridge 458 protrudes from the holder 442 but the rest of the cassette 444 is contained within the holder 442.

The refill cassette 444 also has a mouthpiece (not shown) and an indexing lever 462 for indexing the medicament carrier within the cassette 444.

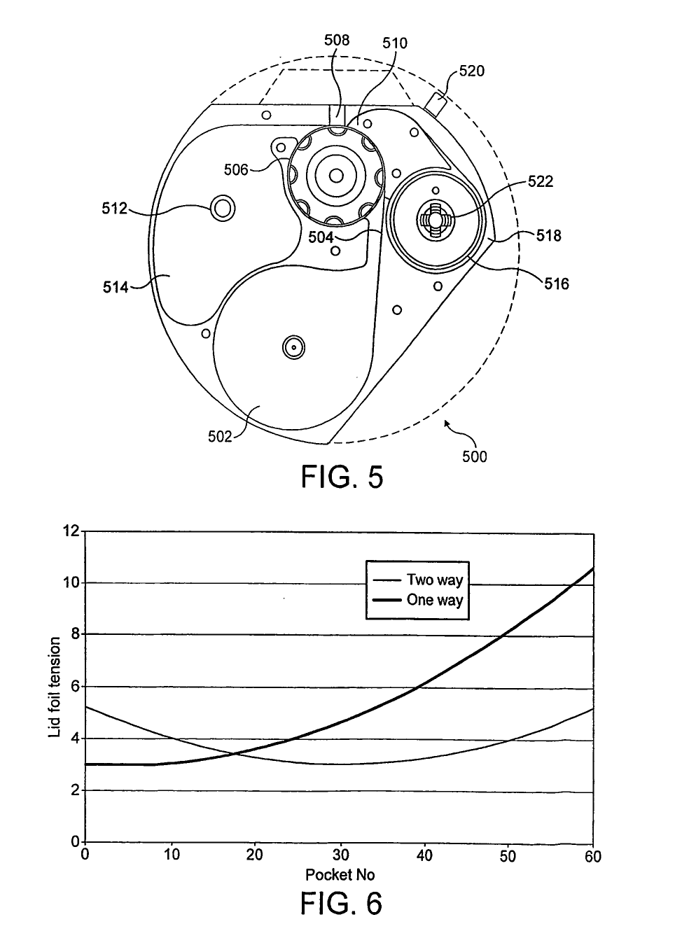

FIG. 5 illustrates a base cassette unit 500 of another medicament dispenser according to the invention. A medicament strip (not shown for clarity) is positioned in chamber 502 of the base unit 500. The strip is pre-fed through a guide member 504 within the manifold component and engaged in eight-pocket index wheel 506. The first pocket of the strip is positioned one pocket away from the opening station 508. The lid foil and base foil are separable about a beak 510. The resulting empty base foil is coiled about a base take-up spindle 512 in the base take-up chamber 514. Used lid foil is feeds over the beak 510 and is coiled about hub-form lid take-up spindle 516 in the lid take-up chamber 518.

To actuate the dispenser, the index lever 520 is turned until it reaches a stop (not shown). The index lever 520 is interconnected with the index wheel 506, the base take-up spindle 512 and the lid take-up spindle 516, through a simple gear train (not visible). The index lever 520 thus indexes the strip and coils up the used foils.

Initially, the gearing between the index wheel 506 and the lid take-up foil spindle 516 is about one-to-one. However, as the lid take up spindle 516 winds on more foil, its effective winding diameter increases. An increase in diameter would cause the lid take-up spindle 516 to pull more strip than the index lever 520 releases. Thus, compensating means in the form of a torsion spring 522, which is positioned in the hub-form lid take-up spindle 516 are provided.

In a first ‘one way take up’ mode of action, the torsion spring 522 is initially tense and the tension thereof reduces as the lid take-up spindle 516 receives lid sheet thereby gradually reducing its drive action as more lid sheet is received thereon. Compensation is thereby provided for the incremental change in effective winding surface diameter of the take-up spindle 516.

In a variation of the dispenser of FIG. 5, the diameter of the hub-form take-up spindle 516 (and hence, its initial effective winding surface diameter) is reduced from that illustrated, and in particular reduced such as to be too small to initially provide uniform (one-to-one) indexing of the medicament carrier. This variation is designed for operation in the ‘two way take up’ mode. In use, as lid sheet winds up around the lid take-up spindle 516 its effective winding surface increases, ultimately to an ideal diameter for uniform indexing of the medicament carrier. However, on further winding up the diameter of the effective winding surface continues to increase to an excessively large diameter. In this mode of usage the torsion spring 522 initially acts such as to compensate for the insufficient lid take-up spindle diameter. That compensation then decreases to zero at the point where the diameter of the effective winding surface is ideal. The compensation then progressively acts such as to compensate for a too great diameter of effective winding surface.

The ‘one way take up’ and ‘two way take up’ modes of action may be better understood by reference to FIG. 6. This shows a graphical representation of the tension experienced (y-axis) by the lid foil of an elongate blister strip-form medicament carrier (e.g. as shown in FIG. 1) versus pocket number of the medicament carrier (x-axis). The pocket number value may be appreciated to relate directly to how much lid foil has been received by a wheel (e.g. take-up spindle 516 of FIG. 5) of the dispenser. The data presented in FIG. 6 relates to a sixty pocket medicament carrier blister strip, thus pocket no. 30 approximately represents the mid-strip point.

As may be seen in FIG. 6, for the ‘one way take up’ mode the lid foil tension is initially moderate and gradually increases as the pocket number increases (i.e. as lid foil is wound up about the wheel) to a much higher value. For the ‘two way take up’ mode the tension is initially moderately high and it very gradually decreases to a minimum at about the mid-strip point (pocket no. 30) before increasing again to a moderately high value at the end-strip point (pocket no. 60). It may be appreciated that the maximum lid foil tension experienced in the ‘two way take up’ mode is less than that for the ‘one way take up’ mode. Thus, in general smaller, less involved and more compact compensating means may be employed for the ‘two way take up’ mode embodiments. It may also be appreciated that a more uniform lid foil tension is experienced in the ‘two way take up’ mode which can be beneficial from a structural stability standpoint.

Any or all of the dispensers shown in FIGS. 2, 3 and 5 may be adapted for operation in the ‘two way take up’ mode by appropriate selection of wheel diameter.

It may be appreciated that any of the parts of the dispenser or cassette which contact the medicament suspension may be coated with materials such as fluoropolymer materials (e.g. PTFE or FEP) which reduce the tendency of medicament to adhere thereto. Any movable parts may also have coatings applied thereto which enhance their desired movement characteristics. Frictional coatings may therefore be applied to enhance frictional contact and lubricants (e.g. silicone oil) used to reduce frictional contact as necessary.

The medicament dispenser of the invention is suitable for dispensing medicament, particularly for the treatment of respiratory disorders such as asthma and chronic obstructive pulmonary disease (COPD), bronchitis and chest infections. Appropriate medicaments may thus be selected from, for example, analgesics, e.g., codeine, dihydromorphine, ergotamine, fentanyl or morphine; anginal preparations, e.g., diltiazem; antiallergics, e.g., cromoglycate (e.g. as the sodium salt), ketotifen or nedocromil (e.g. as the sodium salt); antiinfectives e.g., cephalosporins, penicillins, streptomycin, sulphonamides, tetracyclines and pentamidine; antihistamines, e.g., methapyrilene; anti-inflammatories, e.g., beclomethasone (e.g. as the dipropionate ester), fluticasone (e.g. as the propionate ester), flunisolide, budesonide, rofleponide, mometasone e.g. as the furoate ester), ciclesonide, triamcinolone (e.g. as the acetonide) or 6α, 9α-difluoro-11β-hydroxy-16α-methyl-3-oxo-17α-propionyloxy-androsta-1,4-diene-17β-carbothioic acid S-(2-oxo-tetrahydro-furan-3-yl) ester; antifussives, e.g., noscapine; bronchodilators, e.g., albuterol (e.g. as free base or sulphate), salmeterol (e.g. as xinafoate), ephedrine, adrenaline, fenoterol (e.g. as hydrobromide), formoterol (e.g. as fumarate), isoprenaline, metaproterenol, phenylephrine, phenylpropanolamine, pirbuterol (e.g. as acetate), reproterol (e.g. as hydrochloride), rimiterol, terbutaline (e.g. as sulphate), isoetharine, tulobuterol or 4-hydroxy-7-[2-[[2-[[3-(2-phenylethoxy)propyl]sulfonyl]ethyl]amino]ethyl-2(3H)-benzothiazolone; adenosine 2a agonists, e.g. 2R,3R,4S,5R)-2-[6-Amino-2-(1S-hydroxymethyl-2-phenyl-ethylamino)-purin-9-yl]-5-(2-ethyl-2H-tetrazol-5-yl)-tetrahydro-furan-3,4-diol (e.g. as maleate); α₄ integrin inhibitors e.g. (2S)-3-[4-({[4-(aminocarbonyl)-1-piperidinyl]carbonyl}oxy)phenyl]-2-[((2S)-4-methyl-2-{[2-(2-methylphenoxy) acetyl]amino}pentanoyl)amino] propanoic add (e.g. as free acid or potassium salt), diuretics, e.g., amiloride; anticholinergics, e.g., ipratropium (e.g. as bromide), tiotropium, atropine or oxitropium; hormones, e.g., cortisone, hydrocortisone or prednisolone; xanthines, e.g., aminophylline, choline theophyllinate, lysine theophyllinate or theophylline; therapeutic proteins and peptides, e.g., insulin or glucagon; vaccines, diagnostics, and gene therapies. It will be clear to a person skilled in the art that, where appropriate, the medicaments may be used in the form of salts, (e.g., as alkali metal or amine salts or as acid addition salts) or as esters (e.g., lower alkyl esters) or as solvates (e.g., hydrates) to optimise the activity and/or stability of the medicament.

Preferred medicaments are selected from albuterol, salmeterol, fluticasone propionate and beclomethasone dipropionate and salts or solvates thereof, e.g., the sulphate of albuterol and the xinafoate of salmeterol.

Medicaments can also be delivered in combinations. Preferred formulations containing combinations of active ingredients contain salbutamol (e.g., as the free base or the sulphate salt) or salmeterol (e.g., as the xinafoate salt) or formoterol (eg as the fumarate salt) in combination with an anti-inflammatory steroid such as a beclomethasone ester (e.g., the dipropionate) or a fluticasone ester (e.g., the propionate) or budesonide. A particularly preferred combination is a combination of fluticasone propionate and salmeterol, or a salt thereof (particularly the xinafoate salt). A further combination of particular interest is budesonide and formoterol (e.g. as the fumarate salt).

Generally, powdered medicament particles suitable for delivery to the bronchial or alveolar region of the lung have an aerodynamic diameter of less than 10 micrometers, preferably less than 6 micrometers. Other sized particles may be used if delivery to other portions of the respiratory tract is desired, such as the nasal cavity, mouth or throat. The medicament may be delivered as pure drug, but more appropriately, it is preferred that medicaments are delivered together with excipients (carriers) which are suitable for inhalation. Suitable excipients include organic excipients such as polysaccharides (i.e. starch, cellulose and the like), lactose, glucose, mannitol, amino acids, and maltodextrins, and inorganic excipients such as calcium carbonate or sodium chloride. Lactose is a preferred excipient.

Particles of the powdered medicament and/or excipient may be produced by conventional techniques, for example by micronisation, milling or sieving. Additionally, medicament and/or excipient powders may be engineered with particular densities, size ranges, or characteristics. Particles may comprise active agents, surfactants, wall forming materials, or other components considered desirable by those of ordinary skill.

The excipient may be included with the medicament via well known methods, such as by admixing, co-precipitating and the like. Blends of excipients and drugs are typically formulated to allow the precise metering and dispersion of the blend into doses. A standard blend, for example, contains 13000 micrograms lactose mixed with 50 micrograms drug, yielding an excipient to drug ratio of 260:1. Dosage blends with excipient to drug ratios of from 1000:1 to 1:1 may be used. At very low ratios of excipient to drug, however, the drug dose reproducibility may become more variable.

It will be understood that the present disclosure is for the purpose of illustration only and the invention extends to modifications, variations and improvements thereto. The application of which this description and claims form part may be used as a basis for priority in respect of any subsequent application. The claims of such subsequent application may be directed to any feature or combination of features described therein. They may take the form of product, method or use claims and may include, by way of example and without limitation, one or more of the following claims:

1. A medicament dispenser for use with a medicament carrier having a plurality of pockets for containing medicament wherein said pockets are spaced along the length of and defined between two peelable sheets secured to each other, said dispenser having an internal dispensing mechanism for accessing said medicament contained within said medicament carrier, said mechanism comprising,
a) an opening station for receiving a pocket of said medicament carrier;
b) peeling means positioned to engage a base sheet and a lid sheet of a pocket which has been received in said opening station for peeling apart such a base sheet and lid sheet, to open such a pocket, said peeling means including lid driving means for pulling apart a lid sheet and a base sheet of a pocket that has been received at said opening station, said lid driving means comprising a fixed-diameter wheel on which said lid sheet is wound, said wheel having an effective winding surface, the diameter of which increases as more lid sheet is wound about said wheel,
c) an outlet, positioned to be in communication with an opened pocket through which a user can remove medicament from such an opened pocket; and
d) indexing means for indexing in communication with said outlet, pockets of a medicament carrier in use with said medicament dispenser, said indexing means being interconnected with said lid driving means such that movement of one correlates with the movement of the other,
additionally comprising compensating means to compensate for any increase in the diameter of said effective winding surface during use of the dispenser and to thereby ensure that said medicament carrier is uniformly indexed upon each actuation of said dispensing mechanism.

2. A medicament dispenser according to claim 1, wherein said compensating means is resilient in nature.

3. A medicament dispenser according to claim 1, wherein the compensating means is tensioned.

4. A medicament dispenser according to claim 1, wherein the compensating means is positioned between the opening station and the wheel.

5. A medicament dispenser according to claim 4, wherein the compensating means comprises a flexible member positioned between the opening station and the wheel.

6. A medicament dispenser according to claim 5, wherein the flexible member comprises a flexible elongate arm about which the lid sheet is feedable.

7. A medicament dispenser according to claim 4, wherein the compensating means comprises a spring positioned between the opening station and the wheel.

8. A medicament dispenser according to claim 7, wherein the compensating means additionally comprises a piston head mounted on one end of the spring and about which the lid sheet is feedable.

9. A medicament dispenser according to claim 4, wherein the compensating means comprises a sprung-loaded tensioner positioned between the opening station and the wheel.

10. A medicament dispenser according to claim 1, wherein the compensating means is positioned at the wheel.

11. A medicament dispenser according to claim 10, wherein the compensating means comprises a torsion spring positioned at the wheel.

12. A medicament dispenser according to claim 11, wherein the wheel has a hub form shaped such as to accommodate said torsion spring.

13. A medicament dispenser according to claim 10, wherein the compensating means comprises a constant torque device positioned at the wheel.

14. A medicament dispenser according to any of claim 1, wherein the initial effective winding surface is selected such as to initially provide uniform indexing of the medicament carrier.

15. A medicament dispenser according to claim 1, wherein the initial effective winding surface is selected such as to initially provide non-uniform indexing of the medicament carrier.

16. A medicament dispenser according to claim 15, wherein the diameter of the initial effective winding surface is smaller than that required for uniform indexing of the medicament carrier and in use, as lid sheet winds up around the wheel the effective winding surface increases to an ideal diameter and on further winding up further increases to a too great diameter for uniform indexing.

17. A medicament dispenser according to claim 16, wherein the ideal diameter of the effective winding surface corresponds essentially to the point at which half of the lid sheet is wound up on the wheel.

18. A medicament dispenser according to claim 1, wherein said indexing means comprise a rotatable index wheel having recesses therein, said index wheel being engageable with a medicament carrier in use with said medicament dispenser such that said recesses each receive a respective pocket of the base sheet of a medicament carrier in use with said medicament dispenser.

19. A medicament dispenser according to claim 1, wherein said indexing means comprises an indexing ratchet which is moveable between a locked position whereby said ratchet engages a pocket on said medicament carrier and prevents further peeling thereof, and a release position allowing free movement of said medicament carrier, and actuation of said medicament dispenser actuates said lid driving means and releases said index ratchet from said medicament carrier to allow peeling thereof.

20. A medicament dispenser according to any claim 1, further comprising an indexing lever for actuating said dispenser wherein said indexing lever is interconnected with said indexing means and/or said lid driving means.

21. A medicament dispenser according to claim 1, wherein the indexing means and/or the lid driving means are operated by an electronic drive system.

22. A medicament dispenser according to claim 21 wherein the electronic drive system is used in conjunction with a mechanical drive system.

23. A medicament dispenser according to claim 1, wherein the internal mechanism is housed in a cassette.

24. A medicament dispenser according to claim 23 comprising:
a body;
a holder, shaped to fit within said body and movable relative to said body; and
receivable by said holder, said cassette containing said medicament carrier,

25. A medicament dispenser according to claim 24, wherein movement of the holder relative to the body results in movement of the cassette between a first position and a second position such that the cassette is reversibly removable from the holder when the cassette is in the second position.

26. A medicament dispenser according to claim 24, wherein the first position comprises a dispensing position.

27. A medicament dispenser according to claim 26, wherein the second position comprises a non-dispensing position.

28. A medicament dispenser according to claim 24, wherein the holder and body include attaching means to attach the holder to the body.

29. A medicament dispenser according to claim 28, wherein said attaching means comprise a pin and hole system.

30. A medicament dispenser according to claim 24, wherein the holder is pivotally movable relative to the body.

31. A medicament dispenser according to claim 24, wherein the holder is rotationally movable relative to the body.

32. A medicament dispenser according to claim 30, wherein the holder additionally comprises a stop to limit movement of the holder relative to the body to 180°.

33. A medicament dispenser according to claim 24, wherein the holder is slidably movable relative to the body.

34. A medicament dispenser according to claim 24, wherein the holder additionally comprises a catch to retain the cassette.

35. A medicament dispenser according to claim 34, wherein the catch is child resistant.

36. A medicament dispenser according to claim 24, wherein the cassette additionally comprises an indexing lever.

37. A medicament dispenser according to, wherein the cassette additionally comprises a mouthpiece.

38. A medicament dispenser according to claim 37 wherein the body covers the mouthpiece and indexing lever when the cassette is in the non-dispensing position.

39. A medicament dispenser according to claim 24 wherein the cassette additionally comprises a raised portion to fit against the holder.

40. A medicament dispenser according to claim 1, wherein the internal mechanism additionally comprises a first chamber to receive the elongated strip of the medicament carrier when the base sheet and lid sheet are peelably sealed together and a second chamber to receive the base sheet after it has been indexed around the index wheel and separated from the lid sheet.

41. A medicament dispenser according to claim 40, wherein said first chamber and said second chamber are separated by a wall.

42. A medicament dispenser according to claim 41, wherein said wall is movable to adjust the size of the first and second chambers.

43. A medicament dispenser according to claim 24, wherein at least a portion of the body is shaped for ease of grip by the user.

44. A medicament dispenser according to claim 24, wherein the holder includes a thumb or finger grip.

45. A medicament dispenser according to claim 1, wherein operation of the device may be performed with one hand.

46. A medicament dispenser according to claim 1, additionally comprising a medicament carrier having a plurality of pockets containing medicament.

47. A medicament dispenser according to claim 46, wherein the medicament is in powdered or tablet form.

48. A medicament dispenser according to claim 47, wherein the medicament comprises a drug.

49. A medicament dispenser according to claim 48, wherein the drug is selected from the group consisting of albuterol, salmeterol, fluticasone propionate and beclomethasone dipropionate and salts or solvates thereof and any combination thereof.

50. A medicament dispenser according to claim 49, wherein said combination comprises salmeterol xinafoate and fluticasone propionate.

51. A medicament dispenser according to claim 47, wherein the medicament additionally comprises an excipient.

52. A medicament dispenser according to claim 51, wherein said excipient is a sugar.

53. A medicament dispenser according to claim 24 in kit of parts form.

54. A method of delivery of a medicament comprising: (a) providing a medicament dispenser according to claim 1 and (b) dispensing medicament therefrom.
